(19) United States
(12) Patent Application Publication
(10) Pub. No.: US 2017/0267180 A1
(43) Pub. Date: Sep. 21, 2017

(54) VEHICLE MIRROR ASSEMBLY

(71) Applicant: Nissan North America, Inc., Franklin, TN (US)

(72) Inventor: Kyle HAPPY, Walled Lake, MI (US)

(73) Assignee: Nissan North America, Inc.

(21) Appl. No.: 15/074,466

(22) Filed: Mar. 18, 2016

(51) Int. Cl. B60R 1/08; G02F 1/157

(52) U.S. Cl. CPC B60R 1/088; G02F 1/157

(57) ABSTRACT

A vehicle mirror assembly includes a mirror plate, a support member and a housing. The mirror plate has an exposed surface, a back surface and an outer peripheral edge surface extending around the mirror plate from the exposed surface to the back surface. The outer peripheral edge has a groove formed therein. The support member has a base portion and an outer peripheral lip. The outer peripheral lip has a plurality of clip projections that extend toward a central area of the base portion. With the mirror plate installed within the support member, the back surface extends along the base portion and the clip projections of the outer peripheral lip extend into the groove retaining the mirror plate to the support member. The housing has a vehicle mounting portion and an aiming mechanism disposed within the housing. The base portion of the support member is fixed to the aiming mechanism.

### BACKGROUND

Field of the Invention

The present invention generally relates to a vehicle mirror assembly. More specifically, the present invention relates to a mirror assembly that includes a mirror plate with a groove formed along an outer peripheral edge and a support member having a plurality of clip projections that snap-fit into the groove retaining the mirror plate to the support member.

Background Information

Vehicle mirror assemblies are functional structures that include a mirror plate that is fitted within a support member having an outer peripheral lip of the support member. The outer peripheral lip must cover at least a small portion of a viewing surface of the mirror plate in order to properly retain the mirror plate to the support member.

### SUMMARY

One object of the disclosure is to provide a mirror assembly with a mirror plate and a support member where the mirror plate has a groove formed along an outer peripheral edge and the support member has a plurality of clip projections that snap fit into the groove retaining the mirror plate to the support member.

In view of the state of the known technology, one aspect of the present disclosure is to provide a vehicle mirror assembly with a mirror plate, a support member and a housing. The mirror plate has an exposed surface, a back surface opposite the exposed surface, and an outer peripheral edge surface extending around the mirror plate and extending from the exposed surface to the back surface, the outer peripheral edge having a groove formed therein. The support member has a base portion and an outer peripheral lip having a plurality of clip projections that extend toward a central area of the base portion. With the mirror plate installed within the support member the back surface extends along the base portion and the clip projections of the outer peripheral lip extend into the groove retaining the mirror plate to the support member. The housing has a vehicle mounting portion and an aiming mechanism disposed within the housing. The base portion of the support member is fixed to the aiming mechanism.

### BRIEF DESCRIPTION OF THE DRAWINGS

Referring now to the attached drawings which form a part of this original disclosure:

FIG. 1 is a rear view of a vehicle having a vehicle body structure with a pair of side view mirror assemblies attached thereto, one of the side view mirror assemblies being attached to a first side of the vehicle body structure and the other of the side view mirror assemblies being attached to a second side of the vehicle body structure in accordance with a first embodiment;

FIG. 2 is a perspective view of one of the side view mirror assemblies removed from the vehicle body structure showing a mirror plate, a support member and a housing in accordance with the first embodiment;

FIG. 3 is another perspective view of the side view mirror assembly in accordance with the first embodiment;

FIG. 4 is an exploded perspective view of the side view mirror assembly similar to FIG. 3, showing the mirror plate and support member separated from the housing revealing an aiming mechanism within the housing in accordance with the first embodiment;

FIG. 5 is an exploded perspective view of the mirror plate and support member showing clips formed on the support member and a groove formed on a peripheral edge of the mirror plate in accordance with the first embodiment;

FIG. 6 is a perspective view of the support member showing an aiming mechanism attachment side thereof in accordance with the first embodiment;

FIG. 7 is a plan view of the support member showing the aiming mechanism attachment side thereof in accordance with the first embodiment;

FIG. 8 is a plan view of the support member showing a mirror plate attachment side thereof in accordance with the first embodiment;

FIG. 9 is a side view of the support member in accordance with the first embodiment;

FIG. 10 is a cross-sectional view of the mirror plate and support member taken along the line 10-10 in FIG. 4 in accordance with the first embodiment;

FIG. 11 is a cross-sectional view of the support member with the mirror plate removed in accordance with the first embodiment;

FIG. 12 is a cross-sectional view of the mirror plate showing the groove in accordance with the first embodiment; and

FIG. 13 is a cross-sectional view of a mirror plate in accordance with a second embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

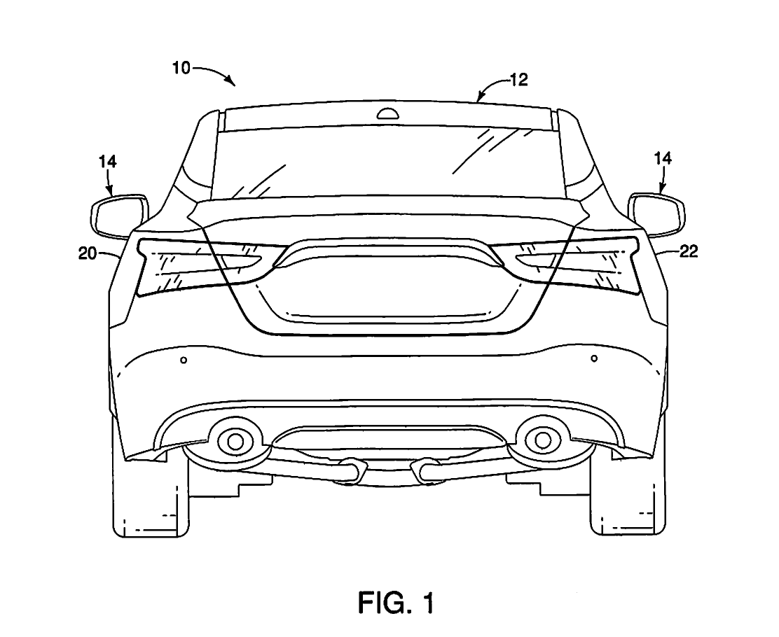

Referring initially to FIG. 1, a vehicle 10 having a vehicle body structure 12 with mirror assemblies 14 is illustrated in accordance with a first embodiment.

The vehicle body structure 12 includes a first side 20 and a second side 22. One of the mirror assemblies 14 is attached to the first side 20 in a conventional manner, and the other of the mirror assembles is attached to the second side 22 of the vehicle body structure 12. It should be understood from the drawings and the description herein that the first side 20 can be defined by a fender portion of the vehicle body structure 12 or a movable door of the vehicle body structure 12. Similarly, the second side 22 can be defined by a fender portion of the vehicle body structure 12 or a movable door of the vehicle body structure 12. Consequently, the mirror assemblies 14 can be attached to either fender portions or door portions of the vehicle body structure 12.

The mirror assemblies 14 are basically identical and have all the same features, but are structural mirror images of one another being symmetrical about a longitudinal center line of the vehicle 10. Consequently, description of only one of the mirror assemblies 14 is provided for the sake of brevity. The description of one of the mirror assemblies 14 applies equally to the other of the mirror assemblies 14.

The mirror assembly 14 basically includes a housing 30, a support member 32 and a mirror plate 34.

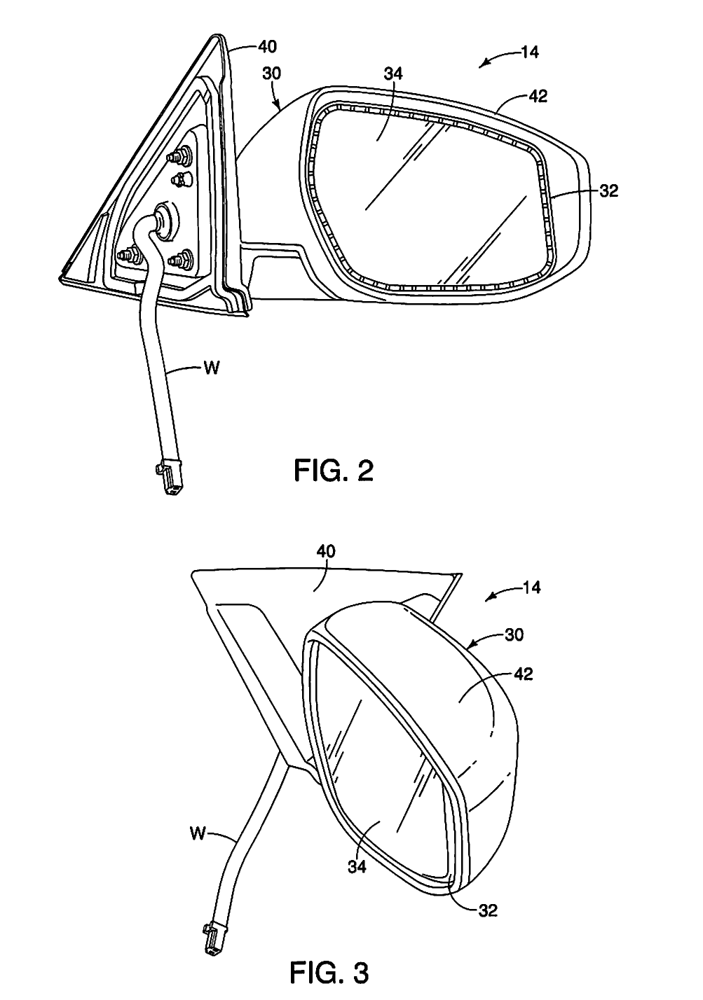

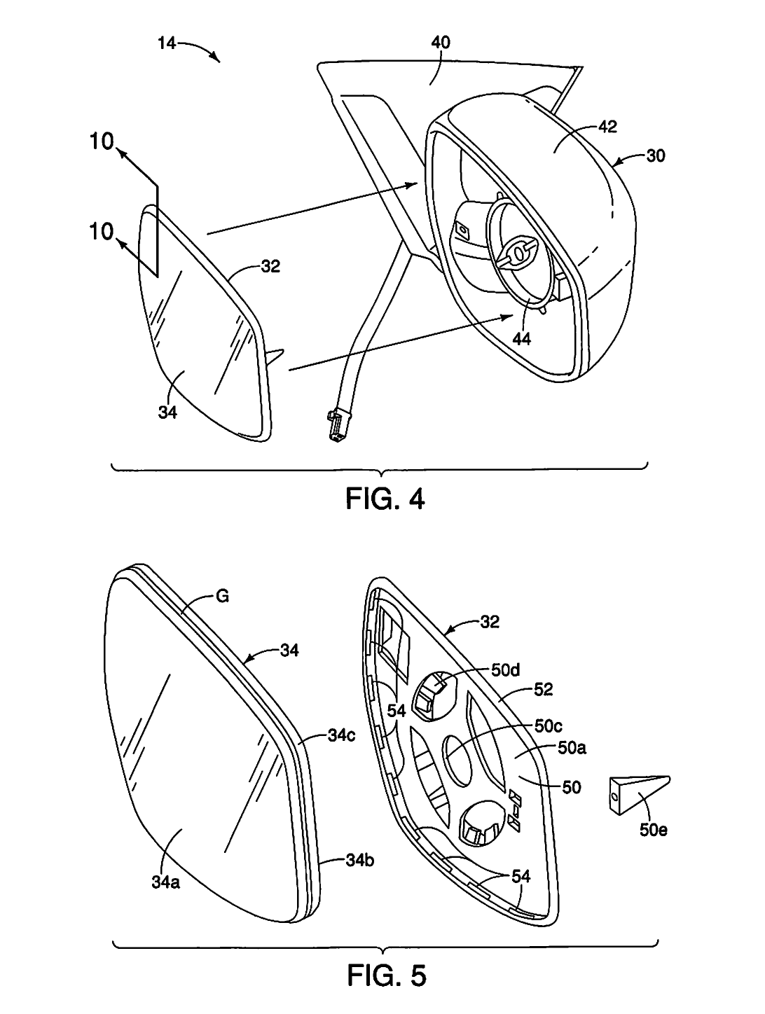

As shown in FIGS. 2-4, the housing 30 includes a vehicle mounting portion 40, a protective shell 42 and an aiming mechanism 44 (FIG. 4) disposed within the protective shell 42 of the housing 30. The vehicle mounting portion 40 is a plate member that includes fasteners for attachment to the vehicle body structure 12 in a conventional manner. A cable W electrically connected to the aiming mechanism 44 is exposed along the vehicle mounting portion 40. The cable W is attached to an aiming switch panel (not shown) within the vehicle 10 when the mirror assembly 14 is installed to the vehicle body structure 12. Since the vehicle mounting portion 40, the protective shell 42 and the aiming mechanism 44 are conventional features of the mirror assembly 14, further description is omitted for the sake of brevity.

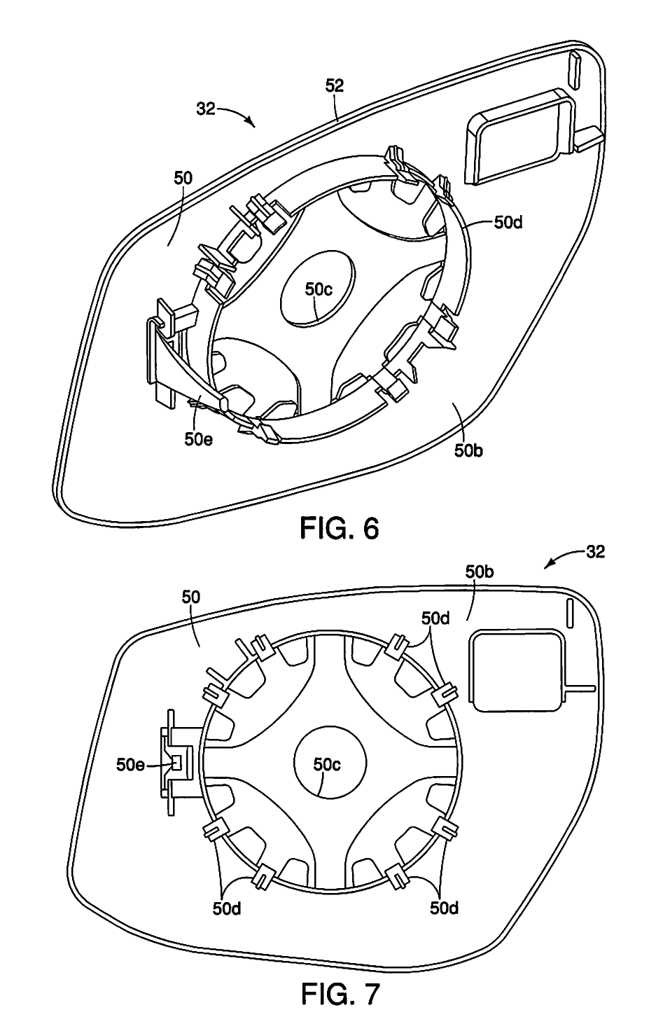

The support member 32 includes a base portion 50 and an outer peripheral lip 52 having a plurality of clip projections 54. The base portion 50 is a generally planar structure with molding openings therein. The base portion 50 has a mirror receiving surface 50a and an aiming mechanism attachment surface 50b. The mirror receiving surface 50a is generally flat and includes a central area 50c that approximately coincides with a circular opening therein. As shown in FIGS. 6, 7 and 9, the aiming mechanism attachment surface 50b includes a plurality of projections 50d and a lever arm 50e. The projections 50d and the lever arm 50e are configured for engagement with the aiming mechanism 44. Since the projections 50d and the lever arm 50e are conventional structures employed by the aiming mechanism 44 for purposes of aiming the mirror plate 34 in conventional manner, further description is omitted for the sake of brevity.

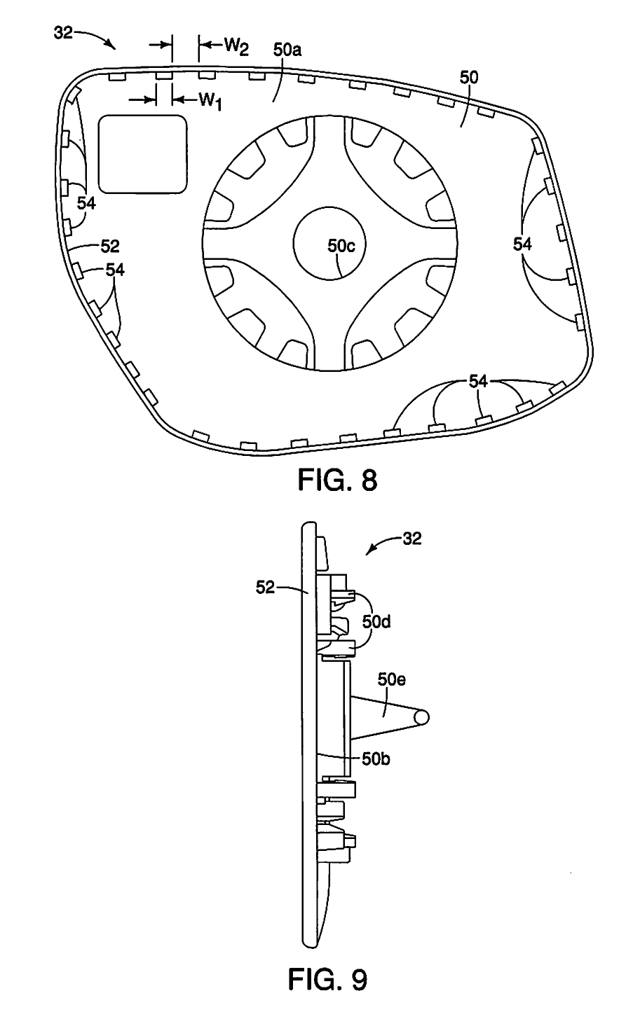

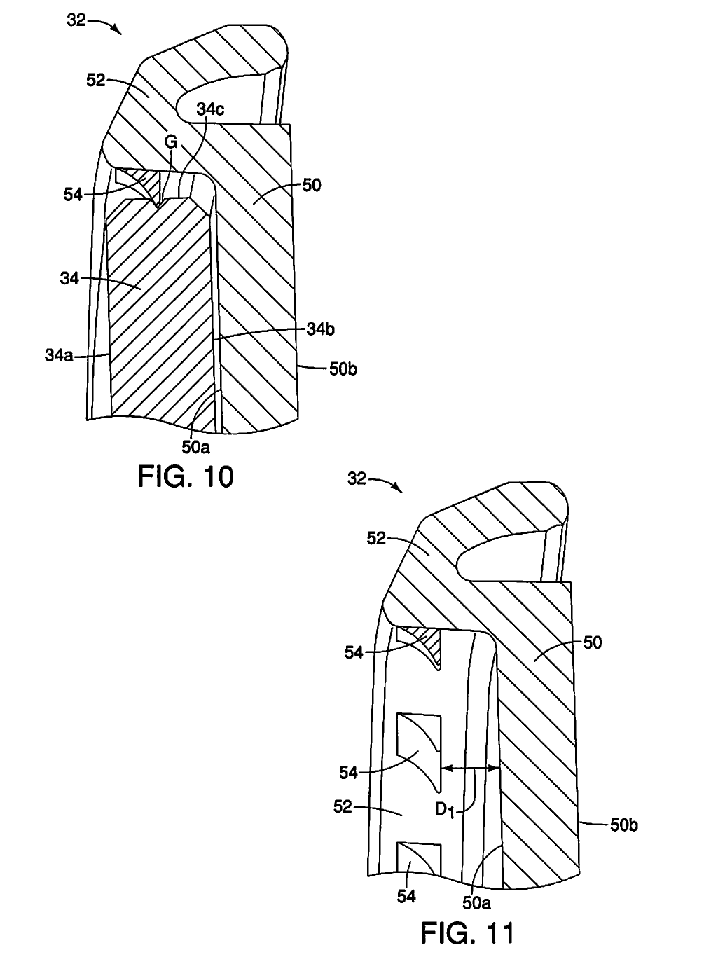

As shown in FIGS. 8, 10 and 11, the mirror receiving surface 50a is generally planar. The outer peripheral lip 52 basically encircles the mirror receiving surface 50a and extends in a direction away from the aiming mechanism attachment surface 50b. Hence, a concave area is defined by the outer peripheral lip 52 and the mirror receiving surface 50a of the support member 32 that receives the mirror plate 34.

The plurality of clip projections 54 extend from the outer peripheral lip 52 toward the central area 50c of the base portion 50 of the support member 32. Distal ends of each of the clip projections 54 are spaced apart from the mirror receiving surface 50a by a first distance D₁, as shown in FIG. 11.

The plurality of clip projections 54 are unitarily formed with the remainder of the support member 32. Specifically, the support member 32, including the base portion 50, the outer peripheral lip 52 and the plurality of clip projections 54 are all formed together as a single element in, for example, a molding or injection molding process.

The plurality of clip projections 54 are spaced apart from one another along the outer peripheral lip 52. Each of the clip projections 54 has an overall width W₁ of at least 2 mm, as shown in FIG. 8. However, some or all of the clip projections 54 can have a larger width, or differing widths. Adjacent ones of the clip projections 54 are spaced apart from one another by a distance W₂ that is at least 5 mm. However, adjacent ones of the clip projections 54 can be spaced apart from one another by any value between 5 mm and 25 mm, depending upon the overall design and configuration of the mirror assembly 14.

Since the support member 32 is a molded element, it can be made of a resilient material that allows a small degree of elastic deformation such that the mirror plate 34 can be inserted into the concave area defined by the base portion 50 and the outer peripheral lip 52. Consequently, the mirror plate 34 is snap-fitted to the support member 32 by the clip projections 54 in a manner described in greater detail below.

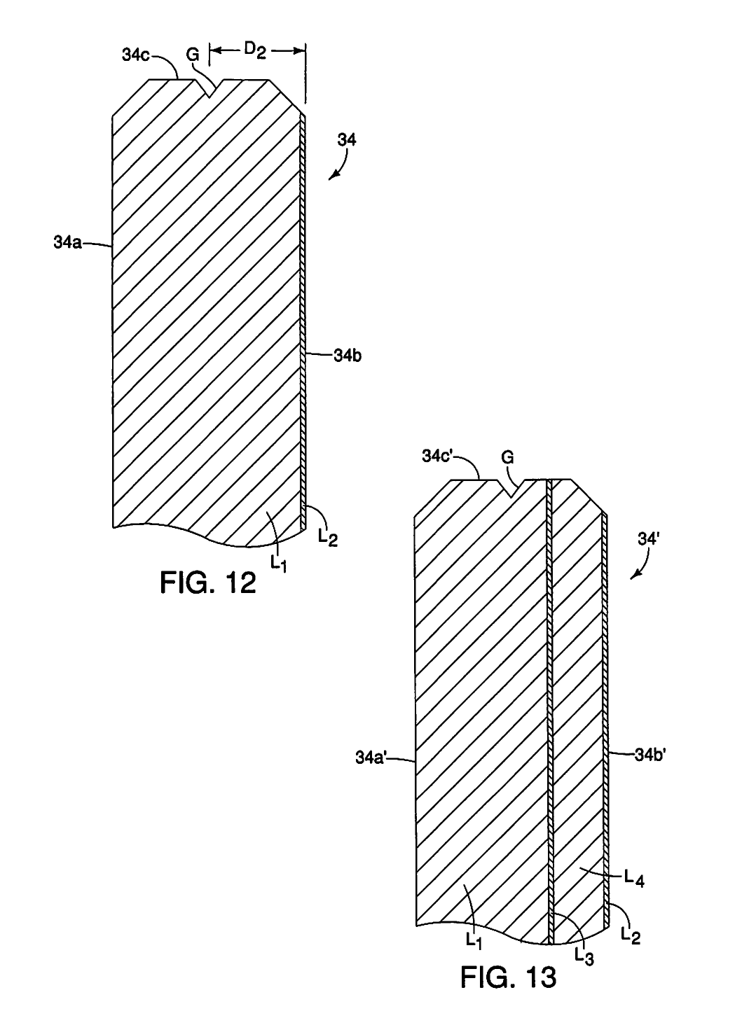

As shown in FIGS. 5 and 10-12, the mirror plate 34 has an exposed surface 34a, a back surface 34b opposite the exposed surface 34a and an outer peripheral edge surface 34c extending around the mirror plate 34. The outer peripheral edge surface 34c extends from the exposed surface 34a to the back surface 34b. The outer peripheral edge surface 34c has a groove G formed therein. In the depicted embodiment, the groove G is a continuous groove extending entirely along the outer peripheral edge surface 34c. Consequently, the groove G encircles both the exposed surface 34a and the back surface 34b. The groove G is spaced apart from the back surface 34b of the mirror plate 34 by a distance D₂. The distance D₁ (distance between the clip projections 54 and the mirror attachment side 50a of the support member 34) and the distance D₂ are approximately equal. However, if an adhesive is used to further secure the mirror plate 34 to the support member 32, then the distance D₁ is preferably slightly larger than the distance D₂. For example, the value of the distance D₁ can be up to 5% larger than the value of the distance D₂.

The groove G is positioned and dimensioned such that the mirror plate 34 fits within the outer peripheral lip 52 of the support member 32 such that the mirror plate 34 snap-fits to the support member 32. Specifically, the clip projections 54 snap-fit into the groove G, thereby retaining the mirror plate 34 to the support member 32 within the outer peripheral lip 52. The back surface 34b of the mirror plate 34 overlays the mirror receiving surface 50a of the base portion 50 of the support member 32. The material used to manufacture the support member 32 has sufficient resiliency to retain the mirror plate 34 in position against the mirror receiving surface 50a of the support member 32, but is also provided with sufficient strength such that the clip projections 54 retain the mirror plate 34 within the support member 32.

When the mirror plate 34 is installed to the support member 32, an optional adhesive material can be applied to either the back surface 34b of the mirror plate 34 or the mirror receiving surface 50a of the support member 32 to further retain the mirror plate 34 to the support member 32.

As shown in 12, the mirror plate 34 includes at least two layers, layer L₁ and a layer L₂. The layer L₁ is a transparent layer made of, for example, glass or transparent polymer material. The layer L₂ is a reflective layer that gives the mirror plate 34 its reflective properties. The layer L₂ is applied to the layer L₁ in a conventional manner. Since glass materials and reflective layer materials are conventional features of a mirror, further description is omitted for the sake of brevity.

### SECOND EMBODIMENT

Referring now to FIG. 13, a mirror plate 34′ in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. The parts of the second embodiment that differ from the parts of the first embodiment will be indicated with a single prime (′).

In the second embodiment, the mirror plate 34′ replaces the mirror plate 34 of the first embodiment. Specifically, the mirror plate 34′ is altered to include an electro-chromatic layer L₃.

The mirror plate 34′ includes the glass layer L₁ and the reflective layer L₂ as described above in the first embodiment. However, the mirror plate 34′ additionally includes the electro-chromatic layer L₃ and a support layer L₄. The layer L₁ is a transparent layer made of, for example, glass or transparent polymer material. The layer L₂ is a reflective layer that gives the mirror plate 34 its reflective properties. The layer L₃ is an electro-chromatic layer that changes optical properties from being transparent to being translucent (to reduce glare at night) in response to application of a predetermined amount of electric current.

The various vehicle elements are conventional components that are well known in the art. Since vehicle elements are well known in the art, these structures will not be discussed or illustrated in detail herein. Rather, it will be apparent to those skilled in the art from this disclosure that the components can be any type of structure and/or programming that can be used to carry out the present invention.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward”, “rearward”, “above”, “downward”, “vertical”, “horizontal”, “below” and “transverse” as well as any other similar directional terms refer to those directions of a vehicle equipped with the mirror assembly. Accordingly, these terms, as utilized to describe the present invention should be interpreted relative to a vehicle equipped with the mirror assembly.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A vehicle mirror assembly, comprising:
a mirror plate having an exposed surface, a back surface opposite the exposed surface, and an outer peripheral edge surface extending around the mirror plate and extending from the exposed surface to the back surface, the outer peripheral edge having a groove formed therein;
a support member having a base portion and an outer peripheral lip having a plurality of clip projections that extend toward a central area of the base portion, such that with the mirror plate installed within the support member the back surface extends along the base portion and the clip projections of the outer peripheral lip extend into the groove retaining the mirror plate to the support member; and
a housing having a vehicle mounting portion and an aiming mechanism disposed within the housing, the base portion of the support member being fixed to the aiming mechanism.

2. The vehicle mirror assembly according to claim 1, wherein
the groove is a continuous groove extending entirely along the outer peripheral edge surface and around the exposed surface and the back surface.

3. The vehicle mirror assembly according to claim 1, wherein the plurality of clip portions are spaced apart from one another by at least 5 mm.

4. The vehicle mirror assembly according to claim 1, wherein
the plurality of clip portions are spaced apart from one another by a distance of between 5 and 25 mm.

5. The vehicle mirror assembly according to claim 1, wherein
the plurality of clip portions are approximately 2 mm wide.

6. The vehicle mirror assembly according to claim 1, wherein
the mirror plate is further retained to the base portion of the support member by an adhesive material.

7. The vehicle mirror assembly according to claim 1, wherein
the mirror plate is a laminated structure having at least a glass layer and a reflective layer.

8. The vehicle mirror assembly according to claim 1, wherein
the mirror plate is a laminated structure having a glass layer, an electro-chromatic layer and a reflective layer.

9. The vehicle mirror assembly according to claim 8, wherein
the electro-chromatic glass layer is a material that changes optical properties from being transparent to being translucent in response to application of a predetermined amount of electric current.

10. The vehicle mirror assembly according to claim 1, wherein
the base portion of the support member includes a mirror receiving surface and an aiming mechanism attachment surface, with the outer peripheral lip extending from the mirror receiving surface in a direction away from the aiming mechanism attachment surface,
each of the plurality of clip projections is spaced apart from the mirror receiving surface by a first distance, and
the groove of the outer peripheral edge surface of the mirror plate is spaced apart from the back surface by a second distance that is less than or equal to the first distance.
